(19) United States
(12) Patent Application Publication
(10) Pub. No.: US 2007/0058149 A1
(43) Pub. Date: Mar. 15, 2007

(54) Lighting system and exposure apparatus

(75) Inventors: Yoshitada Oshida, Ebina-shi (JP); Kazuo Kobayashi, Ebina-shi (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi Via Mechanics, Ltd., Ebina-shi (JP)

(21) Appl. No.: 11/503,976

(22) Filed: Aug. 15, 2006

(30) Foreign Application Priority Data
Sep. 12, 2005 (JP) 2005-263927

(51) Int. Cl. G03B 27/54

(52) U.S. Cl. 355/67; 355/53

(57) ABSTRACT

A lighting system and an exposure apparatus in which even if the outgoing optical axes of outgoing beams emitted from a plurality of LDs disposed on a flat plane are shifted, the efficiency of use of the beams can be improved, and the directivity of lighting can be enhanced. Diffused beams output from a plurality of LDs arrayed two-dimensionally are converted into high-directivity beams with spread angles equalized circumferentially by two kinds of cylindrical lenses. In this event, the optical axis of the beam emitted from each LD may tilt due to misalignment of the center of the beam with the optical axes of the corresponding cylindrical lenses. This tilt is corrected by a wedged glass. Thus, the optical axis of the beam output from each LD meets the optical axis in the entrance plane of an integrator.

### FIELD OF THE INVENTION

The present invention relates to a lighting system for irradiating a to-be-illuminated region with uniform and efficient illuminating light, and an exposure apparatus having the lighting system.

### DESCRIPTION OF THE BACKGROUND ART

In the background art, mercury lamps or excimer lasers are used as light sources for illuminating a to-be-illuminated piece or exposing a to-be-exposed piece to light. However, in these light sources, most of input energy changes into heat. Thus, the light sources are inefficient.

To solve this problem, there is disclosed a technique about a method and an apparatus for illuminating a to-be-illuminated piece with a plurality of light sources with low light emitting energy so that high-performance lighting can be attained with saved energy (JP-A-2004-39871). In JP-A-2004-39871, semiconductor lasers (hereinafter referred to as “LDs”) are used as the light sources, and large-spread-angle beams emitted from the LDs are converted into substantially collimated beams by two kinds of cylindrical lenses, and condensed on an integrator by a condensing optics.

Each LD is in a can-type package (typically circular), and the center of emission is eccentric to the center of the basic outline of the can (hereinafter referred to as the center of the can) by several tens of micrometers up to a maximum of about 80 μm. Accordingly, when the LD is positioned to fit its basic outline, the center of emission may be out of the optical axes of the cylindrical lenses. When the center of emission is out of the optical axes of the cylindrical lenses, light emitted from the LD travels with an inclination Δθ with respect to the optical axis on design. The light is incident on a position displaced from the center of the integrator by fΔθ (f designates the focal length of the condensing optics) as shown by the broken line of FIG. 7.

In order to increase the directivity of lighting, it is effective to increase the focal length f of the condensing optics. However, when the center of emission is eccentric with respect to the center of the can, light output from the LD will be placed out of the integrator farther if the focal length f of the condensing optics is increased. Thus, the efficiency in use of light deteriorates. On the contrary, when the focal length f of the condensing optics is reduced, the directivity of lighting cannot be increased.

### SUMMARY OF THE INVENTION

In order to solve the foregoing problems, an object of the invention is to provide a lighting system and an exposure apparatus in which even if the outgoing optical axes of outgoing beams emitted from a plurality of LDs disposed on a flat plane are shifted, the efficiency of use of the beams can be improved, and the directivity of lighting can be increased.

In order to attain the foregoing object, a first configuration of the present invention provides a lighting system including: a plurality of light sources arrayed two-dimensionally; a beam converting unit for converting light output from the light sources into light beams with high directivity respectively; an integrator for outputting outgoing light to thereby irradiate a to-be-irradiated region with the outgoing light; a condensing optics for directing each optical axis of the high-directivity light beams converted by the beam converting unit toward the center of the integrator; and deflection units provided for deflecting optical paths of the light beams respectively, so as to make each optical axis of the light beams meet the optical axis on the entrance plane of the integrator.

A second configuration of the present invention provides an exposure apparatus including: a plurality of light sources arrayed two-dimensionally; a beam converting unit for converting light output from the light sources into light beams with high directivity respectively; an integrator; a condensing optics for directing each optical axis of the high-directivity light beams converted by the beam converting unit toward the center of the integrator; a pattern display unit for displaying a pattern to be exposed; an optics for irradiating the pattern display unit with light passing through the integrator; a projecting optics for projecting light transmitted or reflected by the pattern display unit onto a to-be-exposed piece so as to expose the to-be-exposed piece to the light; a stage to be mounted with the to-be-exposed piece; a control circuit for driving and controlling the plurality of light sources, the pattern display unit and the stage; and deflection units provided for deflecting optical paths of the light beams respectively, so as to make each optical axis of the light beams meet the optical axis on the entrance plane of the integrator.

According to the present invention, it is possible to improve the efficiency of use of beams output from light sources.

### BRIEF DESCRIPTION OF THE DRAWINGS

FIG. 1 is a general view of an exposure apparatus according to the present invention;

FIG. 2 is a detailed view of a light source system according to the present invention;

FIG. 3 is a view for explaining a spread angle of an outgoing beam emitted from a semiconductor laser;

FIGS. 4A-4C are views for explaining the operation of an optical system according to the present invention;

FIGS. 5A-5C are detailed views of a wedged glass according to the present invention;

FIG. 6 is a view for explaining a modification of the present invention; and

FIG. 7 is a view for explaining the background art.

### DETAILED DESCRIPTION OF THE INVENTION

The present invention will be described below with reference to the drawings.

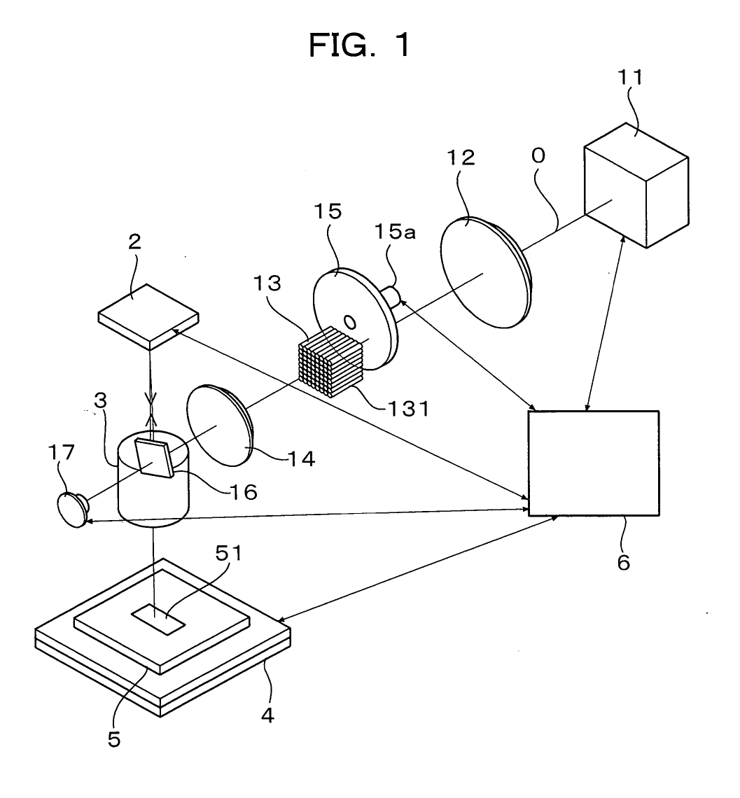

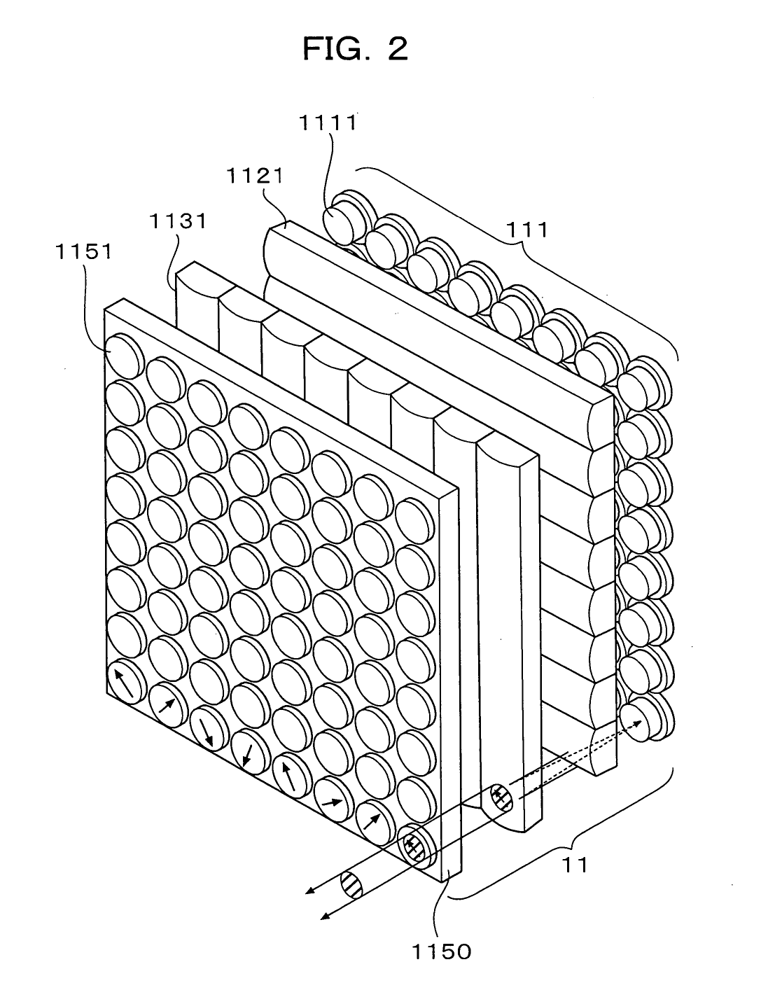

FIG. 1 is a general view of an exposure apparatus according to the present invention, and FIG. 2 is a detailed view of a light source system thereof.

First, description will be made about a general configuration. A first condenser lens 12, a glass disc 15, an integrator 13, a second condenser lens 14 and a beam splitter 16 are disposed along an optical axis O of a central beam of a light source system 11 constituted by a plurality of LDs. A modulating surface 2 such as a mask, a reticle, a two-dimensional light modulator serving for maskless exposure, that is, a liquid-crystal type two-dimensional light modulator, or a DMD (Digital Mirror Device) (herein the modulating surface 2 is a two-dimensional light modulator; and these will be referred to as “mask” collectively), which is on the reflection side of the beam splitter 16, and a projector lens 3 are disposed. A photo-detector 17 is disposed on the transmission side of the beam splitter 16. A table 4 is disposed to face the projector lens 3 movably in two axes perpendicular to each other. A to-be-exposed substrate 5 is fixed on the table 4.

A control circuit 6 controls the light source system 11, a motor 15a, the mask 2 and the photo-detector 17.

Next, respective constituent elements will be described.

As shown in FIG. 2, the light source system 11 is constituted by a light source group 111 where blue (violet) LDs 1111 are arrayed two-dimensionally, a plurality of cylindrical lenses 1121, a plurality of cylindrical lenses 1131 and a plurality of wedged glasses 1151. Each blue (violet) LD 1111 emits light with a wavelength of 405 nm and with a power of about 60 mW individually. Functions of the plurality of cylindrical lenses 1121, the plurality of cylindrical lenses 1131 and the plurality of wedged glasses 1151 will be described later.

An anterior focal point of the first condenser lens 12 is located in a virtual image point 11′ of an LD depending on the cylindrical lenses 1121 and 1131 which will be described later. A posterior local point of the first condenser lens 12 is located in an incoming end of the integrator 13.

The glass disc 15 is made of transparent glass, and irregularities of several μm are formed circumferentially in the surface of the glass disc 15 periodically by units of millimeters. The glass disc 15 is disposed to cross the optical axis O and rotate around an axis parallel to the optical axis O. The motor 15a rotates the glass disc 15.

In the integrator 13, a plurality of rod lenses 131 each having a square section and with a length L are stacked in two directions perpendicular to the optical axis O, in the same manner as in JP-A-2004-39871, so that the optical axis O passes through the center of the integrator 13. Each rod lens 131 has an incoming end face and an outgoing end face. Each end face is a spherical convex surface with a curvature radius R. When n designates the refractive index of glass forming the rod lens 131, the length L of the rod lens 131 is established as L=nR/(n−1).

The front end face (on which light should be incident) of the integrator 13 is positioned on a posterior focal plane of the first condenser lens 12. The rear end face (from which light should be emitted) of the integrator 13 is positioned on an anterior focal point of the condenser lens 14.

The rear end face (outgoing position) of the integrator 13 has an imaging relationship with an entrance pupil of the projector lens 3 through the condenser lens 14. That is, the rear end face of the integrator 13 is positioned on the anterior focal point of the condenser lens 14, and the posterior focal point of the condenser lens 14 is positioned on the anterior focal point of the projector lens 3.

The beam splitter 16 transmits 1% of incident light and reflects the rest.

The mask 2 is a usual chromium or chromium oxide mask or a two-dimensional light modulator such as a liquid-crystal one or a DMD (Digital Mirror Device) having a mask function.

Next, description will be made about the light source system 11 in more detail.

The plurality of LDs 1111 are arrayed in two directions perpendicular to each other on a not-shown plate with an equal pitch and with a uniform density distribution based on their outlines (here eight LDs are arrayed in each direction so that a total of 64 LDs are arrayed) . Thus, the light source group 111 is formed. The area of the light source group 111 is an area generally similar to the shape of a to-be-illuminated area which is a pattern display portion of the mask 2 or the two-dimensional light modulator.

Next, description will be made about a method for controlling the contour of an outgoing beam emitted from each LD 1111.

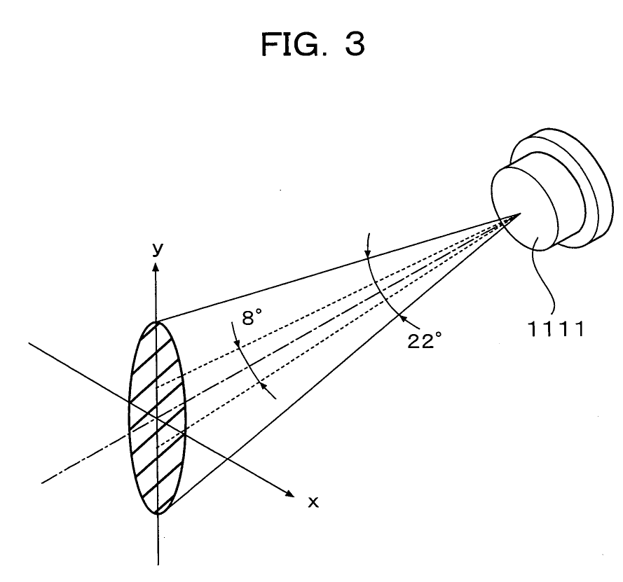

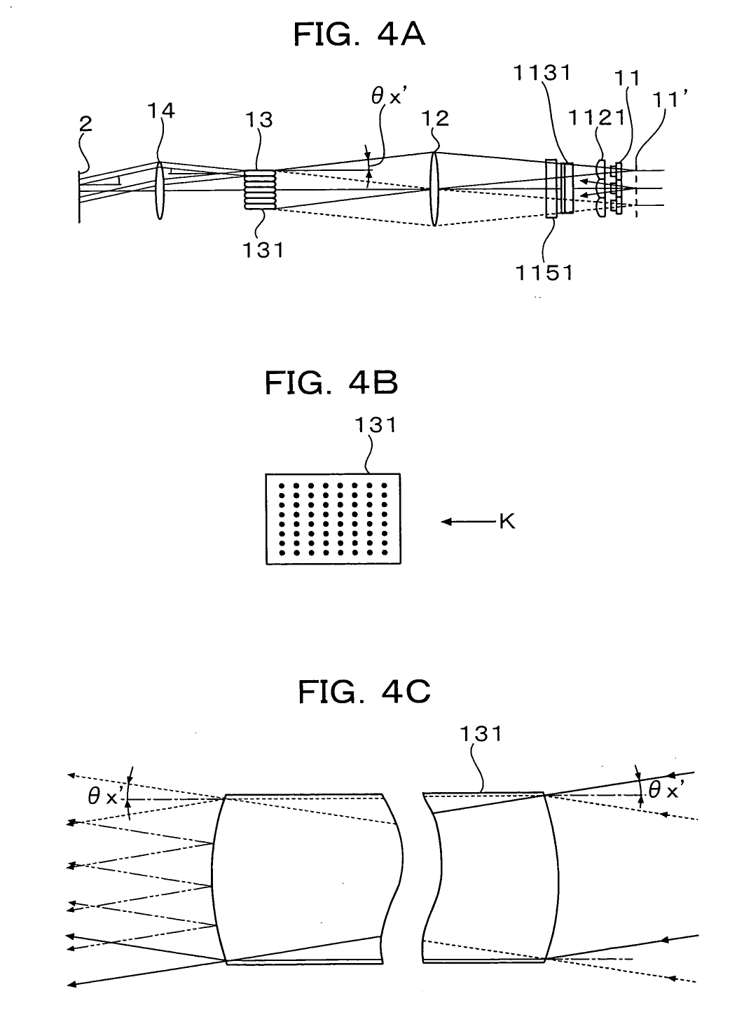

FIG. 3 is a view showing a spread angle of an outgoing beam emitted from the LD 1111. FIGS. 4A-4C are explanatory views of the operation of an optical system. FIG. 4A is a view showing the relationship between emitted light from an LD and incident light to the condenser lens 14 . FIG. 4B is a view of a rod lens 131 observed from the condenser lens 14 side. FIG. 4C is a sectional view along arrow K in FIG. 4B.

As shown in FIG. 3, the spread angle of an outgoing beam emitted from each LD 1111 in an x-direction generally differs from that in a y-direction. For example, the angle from the center of the optical axis to the point where the light energy has decreased by one half in the y-direction is about 22 degrees and about 8 degrees like wise in the x-direction. It is therefore necessary to substantially equalize the spread angles in the two directions or to make them up to 1.5 times as large as each other in order not to cause any trouble.

As shown in FIG. 4A, each cylindrical lens 1121 forms a virtual image of a light source in a virtual image position 11′. That is, a beam emitted from the LD 1111 becomes equivalent to a beam emitted from a point light source (hereinafter also referred to as “point light source 11′”) disposed in the virtual image position 11′. After a laser beam having a spread angle of 22 degrees in the y-direction in the case where it was emitted from the LD is transmitted through the cylindrical lens 1121, the spread angle changes into about 1 degree.

In the same manner, each cylindrical lens 1131 (the focal length of the cylindrical lens 1131 is longer than the focal length of the cylindrical lens 1121) arrayed in the x-direction forms a virtual image of the light source substantially in the virtual image position 11′. That is, a laser beam is emitted as if the laser beam were emitted from the point light source 11′. Thus, the laser beam having a spread angle of 8 degrees around the optical axis in the x-direction in the case where it was emitted from the LD changes into a laser beam with a spread angle of about 1 degree.

When the center of a beam emitted from each LD agrees with the centers of the corresponding cylindrical lenses 1121 and 1131, the LD has an intensity distribution symmetrical about a point individually due to the cylindrical lenses 1121 and 1131. Thus, the laser beam spreading with a spread angle of about 1 degree and having an optical axis parallel to the optical axis O is incident on the first condenser lens 12, and emerges from the first condenser lens 12 in the form of a substantially collimated beam. The substantially collimated beam is transmitted through the glass disc 15 and then incident on the integrator 13. In this case, the incidence angle of the collimated beam incident on the integrator 13 is approximately proportional to the position (x, y) of the LD 1111 in the array 111 shown in FIG. 2. In this manner, the beam from each LD incident on the integrator 13 is a collimated beam having a Gauss distribution close to rotational symmetry around the center (optical axis O) of the entrance plane of the integrator 13.

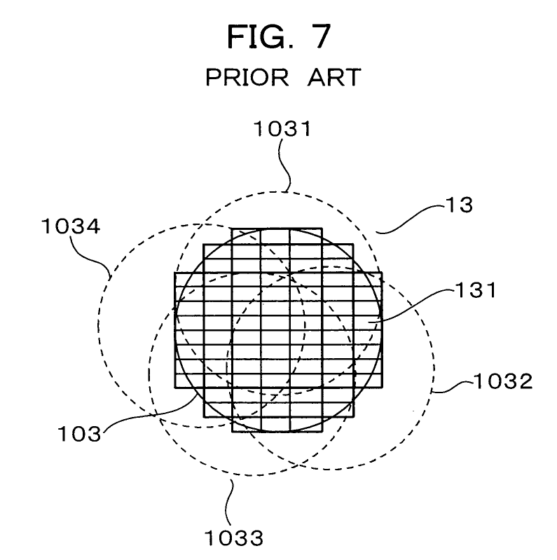

As shown in FIG. 7, all the outgoing beams emitted from the LDs are incident on each rod lens 131. The beams incident on a rod lens 131 are focused on an outgoing end face by the spherical convex lens effect of the entrance surface. That is, as shown in FIG. 4B, all the LDs constituting the light source group 111 are focused (imaged) on the outgoing-side end face of a rod lens 131 in accordance with the layout of the LDs. In FIG. 4A, a beam emitted from each upper LD is shown by the solid line, and a beam emitted from each lower LD is shown by the broken line, while intermediate LDs are not shown.

All the beams emerging from the outgoing end face of the rod lens 131 are formed as outgoing beams having principal rays parallel to the optical axis (parallel to the axis of the rod lens 131) by the spherical convex lens effect of the outgoing surface and without depending on the incident angles of incident beams. As shown in FIG. 4C, the spread angle of the beams emerging from the outgoing end face is formed so that the maximum values of angles with which the beams are incident on the rod lens 131 are θx′ and θy′ (the suffix x designates an angle in the x-direction, and the suffix y designates an angle in the y-direction).

Outgoing beams emerging from the integrator 13 are incident on the second condenser lens 14 and go out of the condenser lens 14 in the form of substantially collimated beams. The substantially collimated beams are incident on the mask 2. That is, any one of the beams emerging from each of the rod lenses consisting of the integrator illuminates the whole display area of the mask 2. Thus, the display area of the mask 2 is illuminated uniformly.

Here, it is necessary to form the cylindrical lenses as lenses having a short focal length and a large numerical aperture NA. When a low-refractive-index material is used for the cylindrical lenses, spherical aberration will prevent the diameter of a beams emitted from each of the LDs, from corresponding to the opening diameter of the integrator end width (entrance width) . In this embodiment, therefore, a glass material having a high refractive index (not lower than 1.6) is used as the material of the cylindrical lenses 1121, so that even large-spread-angle rays can be taken into the opening diameter of the integrator 13.

On the other hand, when the center of a beam emitted from the LD 1111 is out of the center of the can, the center of the beam emitted from the LD 1111 is out of the centers of the corresponding cylindrical lenses 1121 and 1131. In this case, the beam emitted from the LD 1111 travels at a tilt angle Δθ with respect to the optical axis O. The beam is incident not on a position 103 (intended position shown by the solid line in FIG. 7), where the optical axis of the parallel beam meets the optical axis O on the entrance plane of the integrator, but on a position 1031-1034 shown by the broken lines and placed out of the optical axis O.

In order to solve this problem, according to the present invention, a wedged glass 1151 is provided for each LD 1111, as shown in FIG. 2.

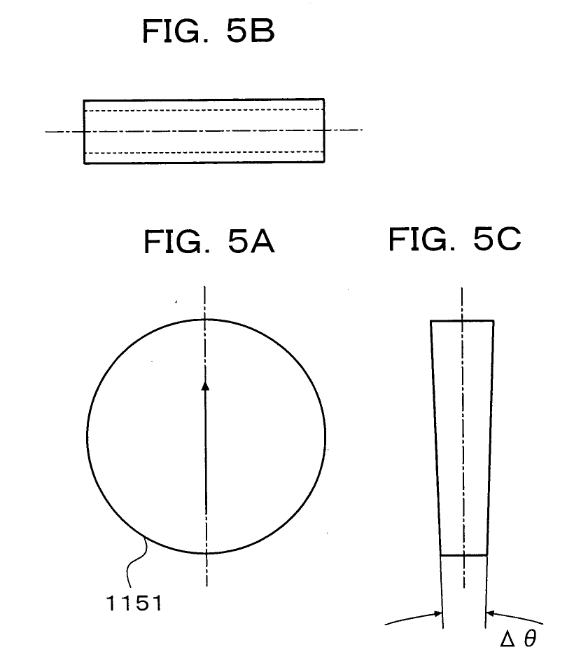

FIGS. 5A-5C are detailed views of a wedged glass 1151 according to the present invention. FIG. 5A is a front view, FIG. 5B is a plan view, and FIG. 5C is a side view.

The wedged glass 1151 has a circular shape with a very slight tilt angle Δθ in the plate thickness direction. A plurality of wedged glasses of angles up to 5-6 minutes at intervals of one minute are prepared as the tilt angle Δθ. When the center of the beam output from the LD 1111 is out of the center of the integrator 13, a wedged glass 1151 which can correct the irradiation shift (angular misalignment) is selected and fixed to a holder 1150 so as to align the angular direction (shown by the arrow in FIG. 5A) of the wedged glass 1151 with the direction of the tilt of the beam (see the arrows illustrated for the wedged glasses 1151 corresponding to the lowest row of LDs in FIG. 2). Thus, about 90% or more of energy of the outgoing beams of the LDs 1111 can be incident on the integrator 13.

Next, the operation of the present invention will be described.

Beams output from the LDs 1111 are converted into beams having spread angles substantially equalized circumferentially by the cylindrical lenses 1121 and the cylindrical lenses 1131 respectively. The optical axes of the beams are made parallel to the optical axis O by the wedged glasses 1151 respectively. The beams are then incident on the first condenser lens 12. The beams transmitted through the glass disc 15 are incident as substantially collimated beams on a position coinciding with the center of the front face of the integrator 13. In this event, the incidence angle of each collimated beam is approximately proportional to the position (x, y) in the array 111 of the LDs 1111 shown in FIG. 1. When the glass disc 15 is rotating, the phase of each collimated beam can be changed by 2π or more in exposure time. As a result, even when the beams output from the LDs 1111 are high in coherence (narrow in spectral width), positions of interference fringes occurring among the beams are changed at a high speed and averaged within the exposure time so that the presence of the interference fringes can be made substantially inconspicuous. Incidentally, the tilt of the optical path of each collimated beam is negligible in practical use when the glass disc 15 is rotating.

The beams transmitted through the integrator 13 (that is, the beams output from the LDs 1111) emerge from the integrator 13 with one and the same spread angle and without depending on their incident angles on the integrator 13. The beams are incident on the second condenser lens 14. Most of the beams converted into collimated beams by the condenser lens 14 are reflected by the beam splitter 16, and incident on the mask 2. The beam emitted from any LD radiates the display portion of the mask 2 substantially uniformly. Thus, the intensity distribution in the masked display portion illuminated by all the LDs becomes uniform with a variation of about ±1%. Beams reflected by ON-state picture element portions of the mask 2 are incident on the projector lens 3 so as to project the pattern of the mask 2 on an exposure area 51 of the to-be-exposed substrate 5 and expose the exposure area 51 therewith.

When the exposure of the exposure area 51 is finished, the table 4 is moved in a direction perpendicular to the exposure direction. A next exposure area 51 is positioned with respect to the projector lens 3.

Here, the control circuit 6 drives and controls the two-dimensional light modulator serving as the mask 2 in accordance with two-dimensional display pattern information, and drives the table 4.

The photo-detector 17 is used for setting the exposure time. That is, the control circuit 6 integrates light intensity detected by the photo-detector 17, and turns off the LDs 1111 as soon as the integrated value reaches a desired setting value (optimum exposure value) specified (stored) in advance. Thus, the exposure is finished.

The pattern of the mask 2 is projected on the exposure area 51 of the to-be-exposed substrate 5 so as to expose the exposure area 51 therewith. When the exposure of the exposure area 51 is finished, the table 4 is moved to position a next exposure area 51 with respect to the projector lens 3.

In this embodiment, the light intensity distribution on the pupil is rotationally symmetric. It is therefore possible to obtain substantially equalized directivity of lighting without depending on the direction of the pattern of the DMD. As a result, it is possible to obtain a resolution characteristic having no dependency on the direction of the pattern. Thus, the substrate can be exposed correctly to light prevented from being distorted.

When a usual mask is used, the substrate 5 is exposed with a pattern drawn on the mask repeatedly. When a two-dimensional light modulator is used, substantially the whole of the substrate 5 is exposed with one set or plural sets of desired patterns.

A desired pattern can be displayed when a two-dimensional spatial modulator is used. Accordingly, when a plurality of exposure optical systems are arranged in the x-direction to scan the substrate 5 in they-direction, it is possible to expose a wider exposure area to light at once.

When each LD 1111 has enough high power, the number of LDs can be reduced so that a large pitch can be secured as the pitch with which the LDs 1111 are arrayed.

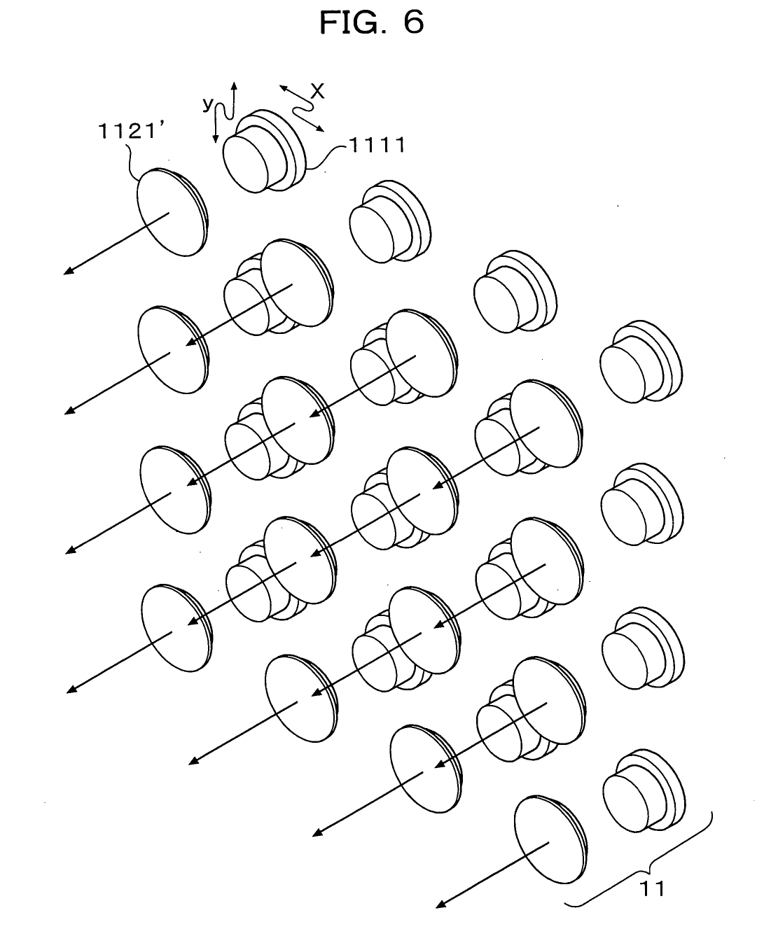

In such a case, as shown in FIG. 6, a means for moving each LD 1111 itself biaxially may be provided in a holder for holding the LD 1111. Thus, the position of the LD 1111 is moved biaxially so that the optical axis of the LD 1111 is positioned on the optical axes of the cylindrical lens 1121 and the cylindrical lens 1131.

In addition, as shown in FIG. 6, the cylindrical lens 1121 and the cylindrical lens 1131 may be replaced by an aspherical lens 1121′ for circumferentially equalizing the spread angle of a beam output from the corresponding LD 1111. In this case, a large number of mechanisms for finely adjusting the relative positions of the aspherical lenses 1121′ have to be provided correspondingly to the number of light sources. Therefore, it is practical to apply this configuration to the case where the packaging density of the light sources is not high, the case where the number of the light sources is small, or the case where the aforementioned means for forming a beam into a high-directivity beam can be provided for each light source individually.

The glass disc 15 may be disposed between the integrator 13 and the condenser lens 14.

1. A lighting system comprising:
a plurality of light sources arrayed two-dimensionally;
a beam converting unit for converting light output from the light sources into light beams with high directivity respectively;
an integrator for outputting outgoing light to thereby irradiate a to-be-irradiated region with the outgoing light;
a condensing optics for directing each optical axis of the high-directivity light beams converted by the beam converting unit toward the center of the integrator; and
deflection units provided for deflecting optical paths of the light beams respectively, so as to make each optical axis of the light beams meet the optical axis on the entrance plane of the integrator.

2. A lighting system according to claim 1, where wedged glasses are used as the deflection units and disposed between the beam converting unit and the integrator, so that the optical paths of the high-directivity light beams converted by the beam converting unit are deflected by the wedged glasses respectively.

3. A lighting system according to claim 1, wherein the deflection units are replaced by units for changing positions where the light sources are retained respectively, so that positions of the light sources relative to the beam converting unit can be changed individually.

4. A lighting system according to claim 1, wherein the beam converting unit includes first cylindrical lenses disposed to face the light sources so as to regulate first-direction spread angles of the light emitted from the light sources, and second cylindrical lenses disposed to face the first cylindrical lenses and extend perpendicularly to the first cylindrical lenses respectively so as to regulate second-direction spread angles of the light emitted from the light sources, and a refractive index of each of the first cylindrical lenses is set to be not lower than 1.6.

5. An exposure apparatus comprising:
a plurality of light sources arrayed two-dimensionally;
a beam converting unit for converting light output from the light sources into light beams with high directivity respectively;
an integrator;
a condensing optics for directing each optical axis of the high-directivity light beams converted by the beam converting unit toward the center of the integrator;
a pattern display unit for displaying a pattern to be exposed;
an optics for irradiating the pattern display unit with light passing through the integrator;
a projecting optics for projecting light transmitted or reflected by the pattern display unit onto a to-be-exposed piece so as to expose the to-be-exposed piece to the light;
a stage to be mounted with the to-be-exposed piece;
a control circuit for driving and controlling the plurality of light sources, the pattern display unit and the stage; and
deflection units provided for deflecting optical paths of the light beams respectively, so as to make each optical axis of the light beams meet the optical axis on the entrance plane of the integrator.
